(19) United States
(12) Patent Application Publication
(10) Pub. No.: US 2025/0357660 A1
(43) Pub. Date: Nov. 20, 2025

(54) BASE STATION ANTENNAS WITH LOW-BAND ARRAYS HAVING LOW-BAND RADIATING ELEMENTS HAVING PARASITIC MONOPOLE ELEMENTS

(71) Applicant: Outdoor Wireless Networks LLC, Richardson, TX (US)

(72) Inventors: Bo Wu, Allen, TX (US); Chengcheng Tang, Murphy, TX (US); Peter J. Bisiules, LaGrange Park, IL (US)

(21) Appl. No.: 19/208,454

(22) Filed: May 14, 2025

Related U.S. Application Data
(60) Provisional application No. 63/648,229, filed on May 16, 2024.

(51) Int. Cl. H01Q 1/24; H01Q 9/20; H01Q 9/30; H01Q 19/26; H01Q 21/06

(52) U.S. Cl. CPC H01Q 1/246; H01Q 9/20; H01Q 9/30; H01Q 19/26; H01Q 21/062

(57) ABSTRACT

Base station antennas include a reflector; a first plurality of cross-dipole radiating elements that are arranged as a first array of cross-dipole radiating elements, each cross-dipole radiating element comprising a first dipole radiator having a first dipole arm and a second dipole arm and a second dipole radiator having a third dipole arm and a fourth dipole arm; and a plurality of parasitic monopole elements that are associated with a first of the cross-dipole radiating elements, each parasitic monopole element including a monopole radiator, wherein at least half of each monopole radiator is positioned within a footprint of the first and second dipole radiators of the first of the cross-dipole radiating elements when the first of the cross-dipole radiating elements is viewed from the front.

### CROSS-REFERENCE TO RELATED APPLICATION

The present application claims priority under 35 U.S.C. § 119 to U.S. Provisional Patent Application Ser. No. 63/648,229, filed May 16, 2024, the entire content of which is incorporated herein by reference.

### FIELD

The present invention generally relates to radio communications and, more particularly, to base station antennas utilized in cellular and other communications systems.

### BACKGROUND

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. Most cells are divided into a plurality of “sectors,” and separate base station antennas provide coverage to each of the sectors. The base station antennas arc often mounted on a tower or other raised structure, with the radiation pattern (“antenna beam”) that is generated by each antenna directed outwardly to serve a respective sector. Typically, a base station antenna includes one or more phase-controlled arrays of radiating elements, with the radiating elements arranged in one or more vertical columns when the antenna is mounted for use. Herein, “vertical” refers to a direction that is generally perpendicular relative to the plane defined by the horizon. References will also be made herein to the “azimuth” and “elevation” planes. The azimuth plane refers to a horizontal plane that bisects the base station antenna that is parallel to the plane defined by the horizon. The elevation plane refers to a plane that is perpendicular to the azimuth plane that bisects the front surface of the base station antenna.

A common base station configuration is a “three sector” configuration in which a cell is divided into three 120° sectors in the azimuth plane, and the base station includes three base station antennas that provide coverage to the three respective sectors so that the base station provides services in all directions in the azimuth plane. In a three sector configuration, the antenna beams generated by each base station antenna typically have an average Half Power Beam Width (“HPBW”) in the azimuth plane of about 65°, as such an antenna beam may provide good coverage throughout a 120° sector without having significant RF energy spill over into the other two sectors. Herein, a HPBW of an antenna beam in the azimuth plane may be referred to as the “azimuth HPBW” and the HPBW of an antenna beam in the elevation plane may be referred to as the “elevation HPBW.” Unless noted otherwise, references to a HPBW of an antenna beam refer to the average HPBW over the operating frequency band of the array of radiating elements that form the antenna beam.

Each individual radiating element in the above-discussed arrays will typically be designed to generate an individual antenna beam (i.e., the antenna beam that is generated if an RF signal is only transmitted through a single radiating element of the array, which is also referred to herein as an “element pattern”) having a HPBW of about 65° in both the azimuth and elevation planes. The azimuth HPBW of an antenna beam generated by an array of radiating elements is a function of (among other things) the azimuth HPBW of the element pattern of the radiating elements (note that typically the radiating elements in an array are identical and hence all have the same element pattern) and the distance between the leftmost and rightmost radiating elements in the array (referred to as the “aperture” of the array in the azimuth plane). As noted above, for a three-sector base station, it is typically desired that the antenna beams generated by an array of radiating elements have an azimuth HPBW of about 65°. Since most radiating elements are designed to have an azimuth HPBW of about 65°, a single radiating element, or a vertically-extending column of radiating elements, will generate antenna beams having the desired 65° azimuth HPBW.

The elevation HPBW of an antenna beam generated by an array of radiating elements is a function of the elevation HPBW of the element pattern of the radiating elements and the distance between the topmost and bottommost radiating elements in the array (i.e., the aperture of the array in the elevation plane). In most applications, cellular operators desire antenna beams having an elevation HPBW that is much smaller than 65°, such as elevation HPBWs of 10°-30°. To narrow the beamwidth in the elevation plane, a column of radiating elements are used so that the aperture of the array in the elevation plane is increased. Such columns of radiating elements are often referred to as “linear arrays.” An RF signal that is to be transmitted by such a linear array is split into a plurality of sub-components that are fed to the respective individual radiating elements in the linear array. The vertical spacing between the radiating elements in the linear array is typically kept below about 0.9*λ, where λ is the wavelength corresponding to the center frequency of the operating frequency band. Keeping the vertical spacing below 0.9*λ helps suppress grating lobe formation, which are undesired sidelobes having peak radiation outside of the azimuth and elevation planes. The more radiating elements that are added to the column (thereby increasing the distance between the topmost and bottommost radiating elements) the narrower the resulting elevation HPBW. If the radiating elements are single-polarized radiating elements, that each linear array will generate a single antenna beam. More typically, however, the linear arrays are formed using dual-polarized radiating elements that have first and second dipole radiators that are fed from different RF ports. When dual-polarized radiating elements are used, each linear array will form an antenna beam at each of two orthogonal polarizations.

Cellular communications are primarily performed in three different frequency ranges, which are commonly referred to as the “low-band,” “mid-band” and “high-band” frequency ranges. The low-band frequency range is generally defined as the 696-960 MHz (or more recently as the 617-960 MHz frequency range). The mid-band frequency range is generally defined as the 1695-2690 MHz (or, more recently as the 1427-2690 MHz frequency range). The high-band frequency range is more variable in nature, but may include different ranges of frequencies in the 3.1-5.8 GHz frequency range. Cellular operators are licensed to use small sub-bands in each of these frequency ranges, where the sub-bands will vary with geographic location and operator. Consequently, particularly for the low-band and mid-band frequency ranges, base station antennas typically include linear arrays that support service across the full low-band and mid-band frequency ranges so that the antennas can be used by any operator in any geographic location.

There is significant interest in base station antennas that include two linear arrays of radiating elements that support service in the same frequency band, as two linear arrays of dual-polarized radiating elements can support 4×multi-input-multi-output (“4×MIMO”) communications. MIMO refers to a communication technique where a baseband data stream is sub-divided into multiple sub-streams that are used to generate multiple RF signals that are transmitted through multiple different arrays of radiating elements. The different arrays are, for example, spatially separated from one another and/or at orthogonal polarizations so that the transmitted RF signals will be sufficiently decorrelated. The multiple RF signals are recovered at the receiver and demodulated and decoded to recover the original data sub-streams, which are then recombined. The use of MIMO transmission techniques may help overcome the negative effects of multipath fading, and may be particularly effective in urban environments where reflections may increase the level of decorrelation between the RF signals. Typically, cellular operators desire antennas that support at least 4×MIMO communications, meaning that the base station antenna must generate four decorrelated antenna beams, which requires two arrays of dual-polarized radiating elements.

Unfortunately, it can be challenging to implement base station antennas that support 4×MIMO in the low-band frequency range in a commercially acceptable manner. The size of a radiating element is inversely correlated with its frequency of operation, and hence the low-band radiating elements are usually the largest radiating elements in a base station antenna. Low-band radiating elements often have widths that exceed 200 mm. As such, including two side-by-side low-band arrays requires an antenna width of more than 400 mm. Moreover, since the radiating elements in each array are configured to be resonant throughout the low-band frequency range, portions of the RF signals transmitted and received by each low-band array will couple to the adjacent array (as the two arrays are in very close proximity to each other), and this coupling can widen the azimuth HPBW of the generated antenna beams. Thus, the radiating elements of the two low-band arrays are typically spaced a minimum distance apart to reduce coupling between the two low-band arrays. As such, providing an antenna that includes two arrays of low-band radiating elements usually results in an antenna having a width exceeding 600 mm, which is undesirable. To keep the size of the base station antenna within acceptable limits, smaller low-band radiating elements are typically used that have widths of about 140-160 mm. However, these smaller low-band radiating elements generate element patterns that have larger HPBWs. The antenna beams generated by such low-band arrays will have lower directivity and gain and more of the RF energy transmitted by these arrays will “spill-over” into adjacent sectors, where the RF energy will appear as interference.

FIG. 1 is a schematic front view of a conventional base station antenna 1 (with the radome thereof removed) that illustrates the difficulty of providing a narrow width base station antenna that includes two linear arrays of low-band radiating elements.

Base station antenna 1 includes first and second arrays 20-1, 20-2 of dual-polarized low-band radiating elements 22. The first and second arrays 20-1, 20-2 will also be referred to herein as “low-band arrays.” In addition, when multiple of the same elements are included in any of the base station antennas disclosed herein, the elements may be referred to individually by their full reference numeral (e.g., low-band array 20-2) and collectively by the first part of their reference numerals (e.g., the low-band arrays 20).

Still referring to FIG. 1, each low-band array 20-1, 20-2 is implemented as a vertically-extending linear array of radiating elements. Typically, the base station antenna 1 will also include two or four linear arrays of mid-band radiating elements as the mid-band radiating elements are smaller and can be mounted behind the low-band radiating elements 22 without increasing the width of the base station antenna 1. Base station antenna 1 is depicted as including two such linear arrays 30-1, 30-2 of mid-band radiating elements 32. To simplify the figures, the base station antennas according to embodiments of the present invention that are disclosed herein are shown as each only including a pair of arrays of low-band radiating elements. It will be appreciated however, that additional arrays of radiating elements may be included in these antennas such as, for example, two or four linear arrays of mid-band radiating elements, and/or one more arrays (including multi-column arrays) of high-band radiating elements.

As shown in FIG. 1, the low-band radiating elements 22 are mounted to extend forwardly from a reflector 10. The reflector 10 may comprise a flat metal surface that serves as a ground plane for the radiating elements 22, 32 and may also redirect RF energy that is emitted rearwardly by the radiating elements 22, 32 in the forward direction. The radiating elements 22 are schematically illustrated in FIG. 1 using X's to indicate that each radiating element 22 is implemented as a slant −45°/+45° cross-dipole radiating element that includes a first dipole radiator 24-1 that transmits and receives RF radiation having a −45° linear polarization and a second dipole radiator 24-2 that transmits and receives RF radiation having a +45° linear polarization. The first dipole radiator 24-1 of each low-band radiating element 22 in the first linear array 20-1 is coupled to a first low-band RF port 12-1 through a first feed network (not shown), and the second dipole radiator 24-2 of each low-band radiating element 22 in the first linear array 20-1 is coupled to a second low-band RF port 12-2 through a second feed network (not shown). The RF ports 12 may be coupled to corresponding ports of a radio (not shown). Thus, RF signals input from the radio to RF port 12-1 are transmitted by the first dipole radiators 24-1 of the radiating elements 22 of the first low-band array 20-1 to generate a first low-band antenna beam (having a +45° polarization), and RF signals input from the radio to RF port 12-2 are transmitted through the second dipole radiators 24-2 of the radiating elements 22 of the first low-band array 20-1 to generate a second low-band antenna beam (having a −45° polarization). The second low-band array 20-2 is coupled to the third and fourth low-band RF ports 12-3, 12-4 in the same manner and hence can generate third and fourth low-band antenna beams. The first and second mid-band linear arrays 30-1, 30-2 are coupled to mid-band RF ports 14-1 through 14-4 in the same manner to generate four mid-band antenna beams.

Base station antennas having the design of base station antenna 1 of FIG. 1 will typically have a width that exceeds 600 mm. Antennas having such large widths are heavy, have very high wind loading, and may exceed local ordinances governing the permissible sizes for base station antennas. While the width of the antenna could be reduced by decreasing the lateral spacing between the linear arrays 20-1, 20-2 of low-band radiating elements 22, spacing the low-band linear arrays 20-1, 20-2 closer together acts to increase the degree of signal coupling between the linear arrays 20-1, 20-2 and this “parasitic” coupling can itself lead to an undesired increase in HPBW. Alternatively, the size of the low-band radiating elements 22 may be reduced to decrease the width of the base station antenna, but the smaller low-band radiating elements 22 have larger azimuth HPBWs and thus the generated antenna beams will tend to have reduced gain and/or spill over into neighboring sectors. Consequently, it may be difficult to provide commercially acceptable base station antennas that support 4×MIMO communications in the low-band frequency range.

A further challenge is that in some jurisdictions the low-band frequency range has been extended to encompass the 617-960 MHz frequency band. Since the size of a radiating element and its resonant frequency are inversely related, low-band radiating elements 22 that operate over the full 617-960 MHz frequency band are even larger than more conventional low-band radiating elements, which results in a corresponding increase in the width of the base station antennas that include two arrays of such radiating elements.

Several different solutions have been proposed for providing based station antennas that support 4×MIMO communications in the low-band frequency range while having reduced widths. For example, base station antennas have been previously suggested that include antenna arrays that comprise a vertically-extending column of radiating elements plus an additional radiating element that is horizontally offset from the main column of radiating elements. The additional radiating element acts to narrow the azimuth beamwidth of the array, thereby allowing smaller radiating elements to be used while still achieving, for example, a 65° azimuth HPBW. However, since one radiating element in each column is included in the linear array formed (primarily) by the adjacent column, the length of each linear array is reduced, which decreases the directivity in the elevation plane (or makes it necessary to increase the length of the antenna to include one more radiating element in each column). Various other techniques have been suggested as discussed, for example, in U.S. patent application Ser. No. 18/499,562, filed Nov. 1, 2023. While these techniques may help narrow the width of a base station antenna, they tend to increase cost and/or reduce the performance of the base station antenna.

### SUMMARY

Pursuant to embodiments of the present invention, base station antennas are provided that include a reflector, a first plurality of cross-dipole radiating elements that are arranged as a first array of cross-dipole radiating elements, each cross-dipole radiating element comprising a first dipole radiator having a first dipole arm and a second dipole arm and a second dipole radiator having a third dipole arm and a fourth dipole arm; and a plurality of parasitic monopole elements that are associated with a first of the cross-dipole radiating elements, each parasitic monopole element including a monopole radiator, wherein at least half of each monopole radiator is positioned within a footprint of the first and second dipole radiators of the first of the cross-dipole radiating elements when the first of the cross-dipole radiating elements is viewed from the front.

In some embodiments, each monopole radiator has an electrical length of between 0.2 and 0.4 of a wavelength within an operating frequency band of the first array. In other embodiments, each monopole radiator has an electrical length of between 0.2 and 0.4 of a center wavelength of an operating frequency band of the first array. In still other embodiments, each monopole radiator has an electrical length of 0.25 of a wavelength within an operating frequency band of the first array.

In some embodiments, at least some of the monopole radiators are electrically connected to the reflector. In some embodiments, the monopole radiators are capacitively coupled to the reflector.

In some embodiments, the entirety of each monopole radiator is positioned within a footprint of the first and second dipole radiators when the first of the cross-dipole radiating elements is viewed from the front.

In some embodiments, at least some of the monopole radiators extend forwardly from the reflector at an angle of between 10° and 80°. In other embodiments, at least some of the monopole radiators extend forwardly from the reflector at an angle of between 20° and 50°.

In some embodiments, a base of each monopole radiator is mounted to extend forwardly from the reflector, and a distal end of each monopole radiator is bent. In some embodiments, distal end of each monopole radiator is bent to extend rearwardly.

In some embodiments, the first of the cross-dipole radiating elements includes a total of four associated parasitic monopole elements.

In some embodiments, a base of each monopole radiator is mounted to extend forwardly from the reflector, and a distal of each monopole radiator is positioned behind a distal end of a respective one of the first through fourth dipole arms of the first of the cross-dipole radiating elements.

In some embodiments, the base station antenna further comprises a second array of cross-dipole radiating elements, where the first array of cross-dipole radiating elements extends as a first column in a longitudinal direction of the reflector and the second array of cross-dipole radiating elements extends as a second column in the longitudinal direction of the reflector.

In some embodiments, at least some of the parasitic monopole elements are cloaked to be substantially transparent to RF energy in an operating frequency band of an array of higher frequency band radiating elements that is included in the base station antenna. In some embodiments, at least some of the monopole radiators include at least a section that is spiraled. In some embodiments, at least one of the monopole radiators includes at least two capacitively coupled conductive segments and at least one meandered inductive segment.

In some embodiments, a base of each monopole radiator is positioned closer to a center of the footprint of the first of the cross-dipole radiating element than is a distal end of each monopole radiator.

In some embodiments, all of the cross-dipole radiating elements in the first array include a plurality of associated parasitic monopole elements.

Pursuant to further embodiments of the present invention, base station antennas are provided that include a reflector; a first plurality of cross-dipole radiating elements that are arranged as a first array of cross-dipole radiating elements, each cross-dipole radiating element comprising a first dipole radiator having a first dipole arm and a second dipole arm and a second dipole radiator having a third dipole arm and a fourth dipole arm; and a plurality of parasitic monopole elements that are associated with a first of the cross-dipole radiating elements, each parasitic monopole element including a monopole radiator, wherein each monopole radiator is positioned at least partly within a footprint of the first and second dipole radiators of the first of the cross-dipole radiating elements when the first of the cross-dipole radiating elements is viewed from the front. At least some of the monopole radiators extend forwardly from the reflector at an angle of between 10° and 80°.

In some embodiments, each monopole radiator has an electrical length of between 0.2 and 0.4 of a center wavelength of an operating frequency band of the first array.

In some embodiments, the monopole radiators are capacitively coupled to the reflector.

In some embodiments, at least half of each monopole radiator is positioned within a footprint of the first and second dipole radiators when the first of the cross-dipole radiating elements is viewed from the front.

In some embodiments, the first of the cross-dipole radiating elements includes a total of four associated parasitic monopole elements.

In some embodiments, a distal of each monopole radiator is positioned adjacent a distal end of a respective one of the first through fourth dipole arms of the first of the cross-dipole radiating elements.

In some embodiments, at least some of the monopole radiators are cloaked to be substantially transparent to RF energy in an operating frequency band of an array of higher frequency band radiating elements that is included in the base station antenna. In some embodiments, at least one of the monopole radiators includes at least a section that is spiraled.

In some embodiments, a base of each monopole radiator is positioned closer to a center of the footprint of the first of the cross-dipole radiating element than is a distal end of each monopole radiator.

Pursuant to additional of the present invention, base station antennas are provided that include a reflector; a first plurality of cross-dipole radiating elements that are arranged as a first array of cross-dipole radiating elements, each cross-dipole radiating element comprising a first dipole radiator having a first dipole arm and a second dipole arm and a second dipole radiator having a third dipole arm and a fourth dipole arm; and a plurality of parasitic monopole elements that are associated with a first of the cross-dipole radiating elements, each parasitic monopole element including a monopole radiator, wherein a base of each monopole radiator is positioned closer to a center of the footprint of the first of the cross-dipole radiating element than is a distal end of each monopole radiator.

In some embodiments, each monopole radiator has an electrical length of 0.25 of a wavelength within an operating frequency band of the first array.

In some embodiments, the base of each monopole radiator is capacitively coupled to the reflector.

In some embodiments, the base of each monopole radiator is positioned within a footprint of the first and second dipole radiators when the first of the cross-dipole radiating elements is viewed from the front.

In some embodiments, at least some of the monopole radiators extend forwardly from the reflector at an angle of between 20° and 60°.

In some embodiments, each of the cross-dipole radiating elements in the first array includes a total of four associated parasitic monopole elements.

In some embodiments, at least some of the monopole radiators include at least a section that is spiraled.

In some embodiments, at least some of the monopole radiators are cloaked to be substantially transparent to RF energy in an operating frequency band of an array of higher frequency band radiating elements that is included in the base station antenna.

Pursuant to still further embodiments of the present invention, base station antennas are provided that include a reflector; a first plurality of cross-dipole radiating elements that are arranged as a first array of cross-dipole radiating elements, each cross-dipole radiating element comprising a first dipole radiator having a first dipole arm and a second dipole arm and a second dipole radiator having a third dipole arm and a fourth dipole arm; and a plurality of parasitic monopole elements that are associated with a first of the cross-dipole radiating elements, each parasitic monopole element including a monopole radiator, where each monopole radiator is electrically coupled to the reflector and extends forwardly from the reflector at an angle of between 10 degrees and 80 degrees.

In some embodiments, each monopole radiator has an electrical length of between 0.2 and 0.4 of a center wavelength of an operating frequency band of the first array.

In some embodiments, at least a portion of each monopole radiator is positioned within a footprint of the first and second dipole radiators when the first of the cross-dipole radiating elements is viewed from the front.

In some embodiments, the first of the cross-dipole radiating elements includes a total of four associated parasitic monopole elements.

In some embodiments, a base of each monopole radiator is positioned closer to a center of the footprint of the first of the cross-dipole radiating element than is a distal end of each monopole radiator.

In some embodiments, at least some of the monopole radiators include at least a section that is spiraled.

In some embodiments, at least some of the monopole radiators are cloaked to be substantially transparent to RF energy in an operating frequency band of an array of higher frequency band radiating elements that is included in the base station antenna.

Pursuant to other embodiments of the present invention, base station antennas are provided that include a reflector; a plurality of cross-dipole radiating elements that are arranged as a first array of cross-dipole radiating elements; a second array of radiating elements, where the second array of radiating elements is configured to operate in a higher frequency band than the first array of radiating elements; and a plurality of parasitic monopole elements that are mounted to extend forwardly from the reflector and that are cloaked to be substantially transparent in an operating frequency band of the array of the second array.

In some embodiments, at least one of the parasitic monopole elements include a monopole radiator that has at least a section that is spiraled.

In some embodiments, at least one of the parasitic monopole elements comprises a monopole radiator that includes at least two capacitively coupled conductive segments and at least one meandered inductive segment.

In some embodiments, each parasitic monopole element includes a monopole radiator, and a base of each monopole radiator is positioned closer to a center of the footprint of the first of the cross-dipole radiating element than is a distal end of each monopole radiator. In some embodiments, each monopole radiator has an electrical length of between 0.2 and 0.4 of a wavelength within an operating frequency band of the first array. In some embodiments, at least some of the monopole radiators extend forwardly from the reflector at an angle of between 10° and 80°.

In some embodiments, the plurality of parasitic monopole elements incudes four parasitic monopole elements that are associated with a first of the cross-dipole radiating elements, and wherein at least a portion of each parasitic monopole element is positioned within a footprint of the first of the cross-dipole radiating elements when the first of the cross-dipole radiating elements is viewed from the front.

Pursuant to yet additional embodiments of the present invention, base station antennas are provided that include a reflector; a first plurality of cross-dipole radiating elements that are arranged as a first array of cross-dipole radiating elements; a second array of radiating elements, where the second array of radiating elements is configured to operate in a higher frequency band than the first array of radiating elements; and a plurality of parasitic monopole elements, each parasitic monopole element including a monopole radiator, wherein at least a portion of each monopole radiator has a spiral shape.

In some embodiments, each monopole radiator has an electrical length of between 0.2 and 0.4 of a wavelength within an operating frequency band of the first array.

In some embodiments, each monopole radiator is electrically connected to the reflector.

In some embodiments, at least some of the monopole radiators are cloaked to be substantially transparent to RF energy in an operating frequency band of the second array.

In some embodiments, first through fourth of the plurality of parasitic monopile elements are associated with a first of the cross-dipole radiating elements, and wherein a base of the monopole radiators of each of the first through fourth of the plurality of parasitic monopole elements is positioned closer to a center of a footprint of the first of the cross-dipole radiating element than is a distal end of each of the monopole radiators.

In some embodiments, at least some of the monopole radiators extend forwardly from the reflector at an angle of between 10° and 80°.

In some embodiments, at least a portion of each monopole radiator is positioned within a footprint of the first and second dipole radiators when the first of the cross-dipole radiating elements is viewed from the front.

### BRIEF DESCRIPTION OF THE DRAWINGS

FIG. 1 is a schematic front view of a conventional base station antenna (with the radome removed) that supports 4×MIMO communications in the low-band frequency range.

FIG. 2A is a schematic side perspective view of a low-band cross-dipole radiating element having associated parasitic monopole elements according to embodiments of the present invention mounted to extend forwardly from a reflector of a base station antenna.

FIGS. 2B and 2C are a side view and a front view, respectively of the low-band cross-dipole radiating element having associated parasitic monopole elements of FIG. 2A.

FIG. 3A is a schematic shadow front perspective view of a portion of a base station antenna that includes two arrays of low-band radiating elements, where the low-band radiating elements are implemented using the low-band cross-dipole radiating element having associated parasitic monopole elements of FIG. 2A.

FIG. 3B is a schematic side view of the base station antenna of FIG. 3A.

FIGS. 4A and 4B are graphs comparing the simulated azimuth HPBW and the directivity, respectively, of the base station antenna of FIGS. 3A-3B as compared to the same base station antenna with the parasitic monopole elements omitted.

FIGS. 5A and 5B are schematic front perspective views of low-band cross-dipole radiating element having associated parasitic monopole elements according to further embodiments of the present invention.

FIGS. 6A-6F are schematic side views additional parasitic monopole elements that may be used in the radiating elements according to embodiments of the present invention.

FIG. 7 is a schematic side perspective view a base station antenna according to further embodiments of the present invention that includes side-by-side arrays of low-band cross-dipole radiating element having associated parasitic monopole elements where the parasitic monopole elements in the two arrays are arranged as mirror images.

FIGS. 8A-8E are schematic perspective views of cloaked parasitic monopole elements according to embodiments of the present invention.

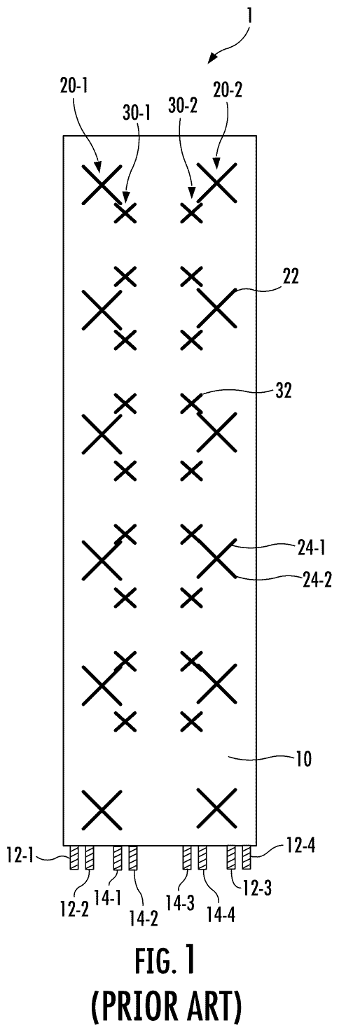

### DETAILED DESCRIPTION

As discussed above, it may be challenging to provide base station antennas that include two side-by-side arrays of low-band radiating elements while keeping both the widths of the base station antennas and the directivity of the arrays within acceptable limits. As such, base station antennas that include two side-by-side arrays of low-band radiating elements typically comprise two very-closely spaced arrays of undersized low-band radiating elements that generate low-band antenna beams having wider azimuth half power and 10 dB beamwidths than desired. For example, the azimuth HPBW of a typical low-band array in a base station antenna having a width of 500 mm that includes two low-band arrays may be over 80 degrees, and the 10 dB azimuth beamwidth may be over 125 degrees. As a result, the directivity of the low-band arrays may be less than desired, and the low-band arrays may have increased interference in neighboring sectors.

Pursuant to embodiments of the present invention, relatively narrow base station antennas (e.g., widths of less than 430 mm) are provided that include two side-by-side arrays of low-band radiating elements that generate low-band antenna beams that have narrower azimuth beamwidths and higher directivity than comparable conventional base station antennas. The base station antennas according to embodiments of the present invention include low-band arrays in which at least some of the low-band radiating elements include associated parasitic monopole elements. These parasitic monopole elements interact with the RF energy emitted by their associated low-band radiating elements and also with the low-band radiating elements in the adjacent array in a manner that acts to significantly narrow the azimuth HPBW of the generated low-band antenna beams.

In some embodiments, the parasitic monopole elements may be positioned so that they at least partially overlap the dipole radiators of the cross-dipole radiating element in the front-to-back direction of the base station antenna. In some embodiments, the parasitic monopole elements may be slanted so that they can have a length that is particularly effective in narrowing the azimuth beamwidth in the lower portion of the low-band operating frequency band while still fitting mostly or completely behind the dipole arms of the respective radiating elements. The parasitic monopole elements may be electrically coupled to the reflector and distal ends of the parasitic monopole elements may be bent rearwardly. In some embodiments, the base of each parasitic monopole elements may be closer to a feed stalk of its associated radiating element than the distal end of the respective parasitic monopole element. The parasitic monopole elements may also be cloaked with respect to RF radiation in the operating frequency band of one or more arrays of additional radiating elements that are included in the base station antenna.

The parasitic monopole elements may comprise metal rods or stamped sheet metal in some embodiments, and hence may be inexpensive to implement. In some embodiments the parasitic monopole elements may be capacitively coupled to the reflector to avoid the need for any soldering operations (and the associated risk for passive intermodulation distortion) and may be held in place by, for example, plastic rivets and/or by the plastic supports that hold the dipole arms of the radiating elements in place. Moreover, the low-band arrays may be formed using conventional low-band radiating elements, and thus it is not necessary to separately develop new low-band radiating elements that are designed to work with the parasitic monopole elements.

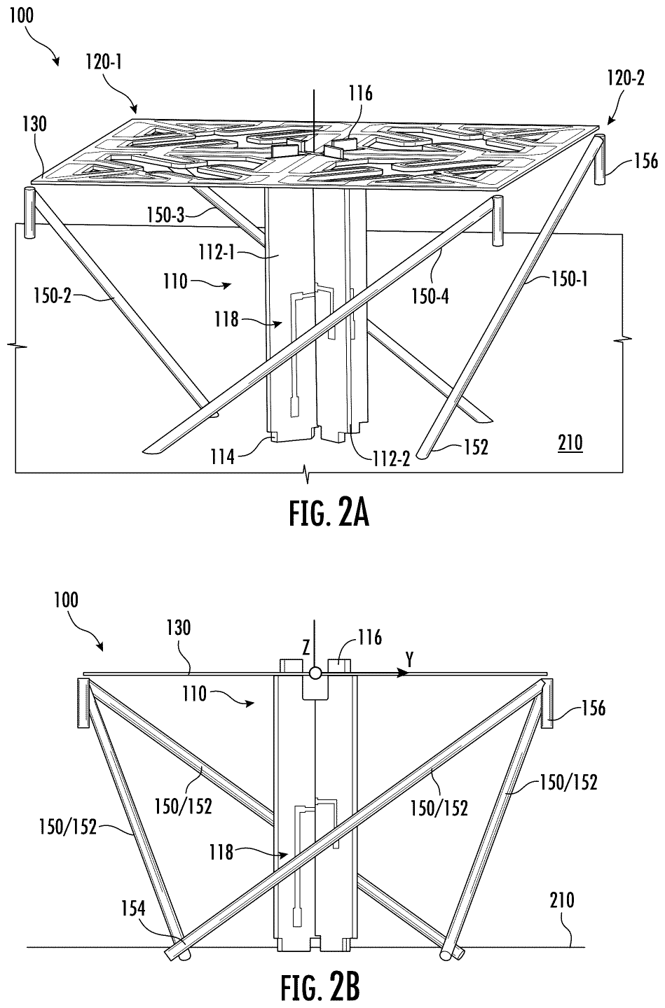

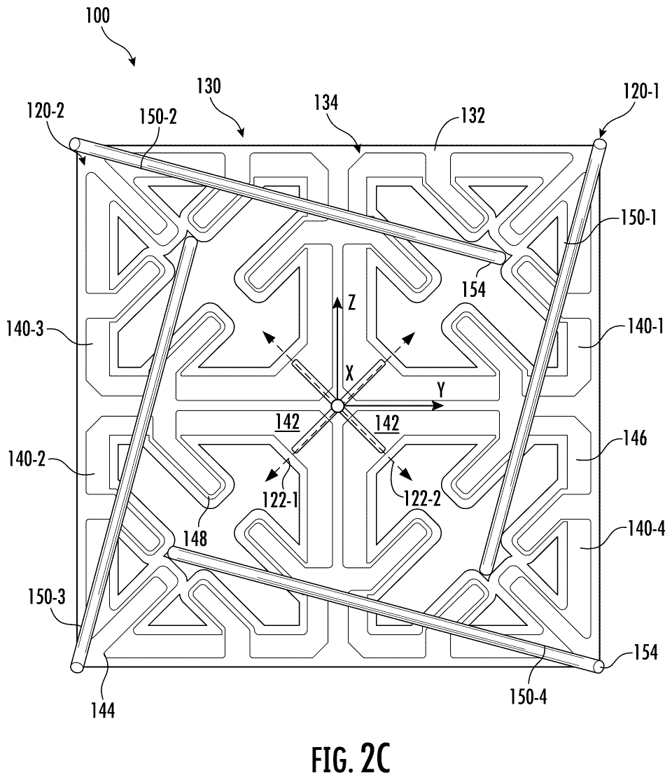

Embodiments of the present invention will now be discussed in more detail with reference to FIGS. 2A-8E.

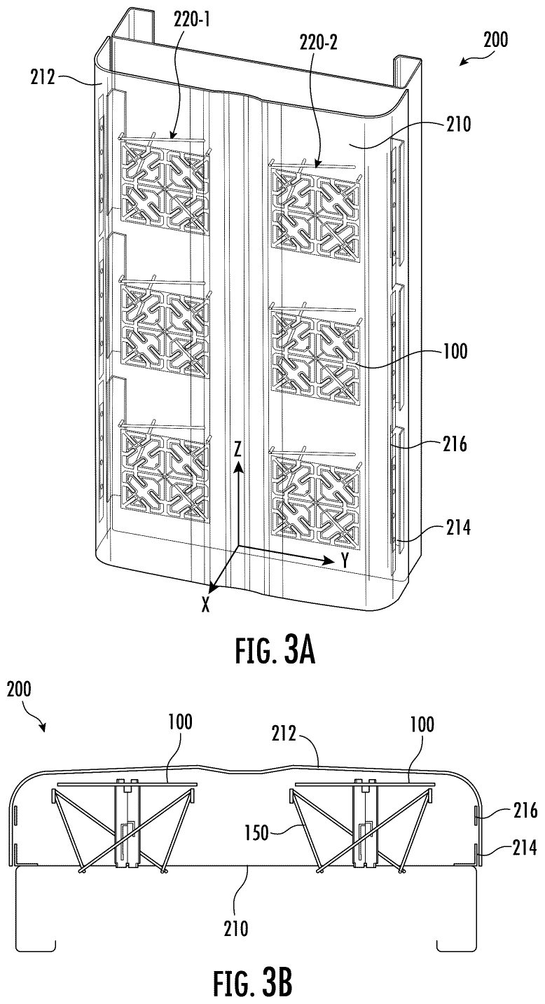

FIG. 2A is a schematic side perspective view of a low-band cross-dipole radiating element 100 having associated parasitic monopole elements 150 according to embodiments of the present invention. In the view of FIG. 2A, the low-band cross-dipole radiating element 100 is shown mounted so that it extends forwardly from a reflector of a base station antenna such as the reflector 210 of the base station antenna 200 illustrated in FIGS. 3A-3B (discussed below).

FIGS. 2B and 2C are a side view and a front view, respectively of the low-band cross-dipole radiating element 100 of FIG. 2A.

Referring to FIG. 2A, low-band cross-dipole radiating element 100 includes a feed stalk 110 and first and second dipole radiators 120-1, 120-2. The feed stalk 110 is implemented as a pair of feed stalk printed circuit boards 112-1, 112-2 that have matching slits that allow the feed stalk printed circuit boards 112-1, 112-2 to be mated together so that the feed stalk 110 has an X-shape when viewed from the front. A base 114 of the feed stalk 110 may be mounted on a front surface of a reflector 210, as shown. Typically, the base 114 of the feed stalk 110 is physically mounted on, and electrically connected to, a feed board printed circuit board (not shown) and the feed board printed circuit board is mounted on the front surface of the reflector 210. Each feed stalk printed circuit board 112 may include an RF transmission line 118 that is used to couple RF signals between a respective one of the dipole radiators 120 and a feed network (not shown) for the base station antenna, as is well understood in the art. It will be appreciated that while radiating element 100 has a feed stalk 110 that comprises a pair of feed stalk printed circuit boards 112-1, 112-2, embodiments of the present invention are not limited thereto, and the radiating elements 100 may have any appropriate feed stalk design including, for example, sheet metal feed stalks, single printed circuit board feed stalks, die cast or machined feed stalks or feed stalks that comprise a pair of feed cables.

Referring to FIGS. 2A and 2C, the first and second dipole radiators 120-1, 120-2 are formed on a dipole radiator printed circuit board 130. The dipole radiator printed circuit board 130 comprises a dielectric substrate 132 having a metallization pattern 134 formed on one side thereof. The metallization pattern 134 forms the first and second dipole radiators 120-1, 120-2. The first dipole radiator 120-1 comprises first and second dipole arms 140-1, 140-2 that extend along a common axis 122-1. The axis 122-1 may extend at an angle of about 45° when the radiating element 100 is mounted for use in a base station antenna so that dipole radiator 120-1 is configured to transmit and receive RF signals having a slant +45° linear polarization. The second dipole radiator 120-2 comprises third and fourth dipole arms 140-3, 140-4 that extend along a common axis 122-2. The axis 122-2 may extend at an angle of about −45° when the radiating element 100 is mounted for use in a base station antenna so that dipole radiator 120-2 is configured to transmit and receive RF signals having a slant −45° linear polarization. The first and second axes 122-1, 122-2 cross each other so that the first and second dipole radiators 120-1, 120-2 have a so-called “cross-dipole” configuration.

Each dipole arm 140 has a square shape and forms a conductive loop. Each dipole arm 140 has a base 142 and a distal end 144. The bases 142 of the four dipole arms 140-1 through 144-4 are positioned next to each other in the center of the radiating element 100 (when the radiating element 100 is viewed from the front), as is best shown in FIG. 2C. The feed stalk printed circuit boards 112 include forwardly extending tabs 116 that extend through the dipole radiator printed circuit board 130 at the base 142 of each dipole arm 140. Each dipole arm 140 comprises a plurality of widened conductive segments 146 that connected by narrow trace sections 148. The narrowed trace sections 148 may be implemented as meandered conductive traces. Herein, a meandered conductive trace refers to a non-linear conductive trace that follows a meandered path to increase the path length thereof. The meandered conductive trace sections 148 may have extended lengths yet still have a small physical footprint.

As shown best in FIG. 2C, each dipole arm 140 may comprise a loop that includes a series of alternating widened conductive members 146 and narrowed trace sections 148. Each pair of adjacent widened conductive members 146 may be physically and electrically connected by a respective one of the narrowed trace sections 148. Since the narrowed trace sections 148 have a small physical footprint, adjacent widened conductive members 146 may be in close proximity to each other so that the widened conductive members 146 together appear as a single dipole arm at frequencies within the operating frequency range of the low-band radiating element 100. It will be appreciated that in other embodiments, the dipole arms 140 need not have a closed loop design as explained. As shown, the dipole arms 140-1 through 140-4 may each have the same design, and project radially outward from the center of the dipole printed circuit board 130.

As is understood by those of skill in the art, a phenomena known as “scattering” may occur when RF radiation emitted by a higher frequency band array of radiating elements is incident on the radiating elements of a lower frequency band array of radiating elements. Scattering occurs because the lower frequency band radiating elements are often resonant at the frequency of the higher frequency band RF radiation. For example, most base station antennas that include linear arrays of low-band radiating elements also include linear arrays of mid-band radiating elements. The mid-band operating frequency band includes many frequencies that are about twice the frequency of frequencies in the low-band operating frequency band. Since the dipole arms of a low-band radiating element have an electrical length of about % a wavelength of the center frequency of the 696-960 MHz low-band operating frequency range, the dipole arms of the low-band radiating elements will have an electrical length of about h of a wavelength for many of the frequencies of the 1427-2690 MHz mid-band operating frequency band, and hence the dipole arms of the low-band radiating elements will tend to resonate in response to mid-band RF radiation. As such, when RF radiation emitted by nearby mid-band radiating elements is incident on a low-band radiating element, the mid-band RF energy may generate RF currents on the dipole arms of a low-band radiating element, and those RF currents may then cause the mid-band RF energy to reradiate from the low-band radiating element, often in undesired directions. This unintended reradiation of the mid-band RF radiation (i.e., scattering) may negatively impact the beamwidth, beam shape, pointing angle, gain and/or front-to-back ratio of the mid-band antenna beams.

The narrowed meandered trace sections 148 are designed to act as high impedance sections that interrupt the mid-band RF currents that would otherwise form on the dipole arms 140 of the low-band radiating element 100 in response to RF radiation transmitted by nearby mid-band radiating elements (not shown). The narrowed meandered trace sections 148 do not significantly impact the ability of the low-band currents to flow on the dipole arms 140. In some embodiments, the narrowed trace sections 148 may make the low-band radiating element 100 almost invisible to nearby mid-band radiating elements, and thus the low-band radiating element 100 may not distort the mid-band antenna beams.

The widened conductive member 146 at the base 142 of each dipole arm 140 has a slot 145 formed therethrough. These slots 145 extend all the way through the printed circuit board 130. The forwardly-extending tabs 116 on the feed stalks 110 may extend through the respective slots 145 to electrically connect each feed stalk printed circuit board 112 to a respective one of the dipole arms 140, either through galvanic or capacitive connections.

It will be appreciated that the dipole radiator design shown in FIGS. 2A-2C in which the dipole radiators 120-1, 120-2 are formed on a printed circuit board 130 having a single metallization layer 134 is provided merely as an example, and that any appropriate dipole radiator design may be used. For example, in other cases, the dipole radiators may be formed as sheet metal dipole arms, die cast dipole arms, on printed circuit boards including more than one metallization layer, or using a combination of such technologies (e.g., dipole radiators formed using both printed circuit boards and sheet metal). Thus, it will be understood that the parasitic monopole elements according to embodiments of the present invention may be used with any low-band radiating element to improve the performance thereof. Moreover, while the example embodiments of radiating elements discussed herein are low-band radiating elements, it will be appreciated that the parasitic monopole elements according to embodiments of the present invention may be used in the exact same fashion to improve the performance of mid-band or high-band radiating elements.

As is further shown in FIGS. 2A-2C, the low-band radiating element 100 has a plurality of associated parasitic monopole elements 150. Each parasitic monopole element 150 includes a monopole radiator 152. In some embodiments, each monopole radiator 152 may comprise a metal structure that has an electrical length of between 0.2 and 0.4 of a wavelength that is within an operating frequency band of radiating element 100. In some cases, the electrical length may be between 0.2 and 0.4 of the wavelength that corresponds to a center frequency of the operating frequency band of radiating element 100. In other cases, the electrical length may be 0.25 of a wavelength that is within the operating frequency band of radiating element 100. In the depicted embodiment, each parasitic monopole element 150 simply comprises a metal rod that acts as the monopole radiator 152. The monopole radiator 152 has a base 154 that is positioned adjacent the reflector 210, and a distal end 156 that is positioned adjacent the dipole radiator printed circuit board 130. Each monopole radiator 152 extends forwardly from the reflector 210 at an oblique angle α. In example embodiments, the oblique angle may be between 10° and 80°. In some embodiments, the oblique angle α may be between 20° and 50°. The distal end 156 of each monopole radiator 152 may be bent relative to the remainder of the monopole radiator 152. For example, in the depicted embodiment, the last 10-15% of each monopole radiator 152 is bent to extend rearwardly.

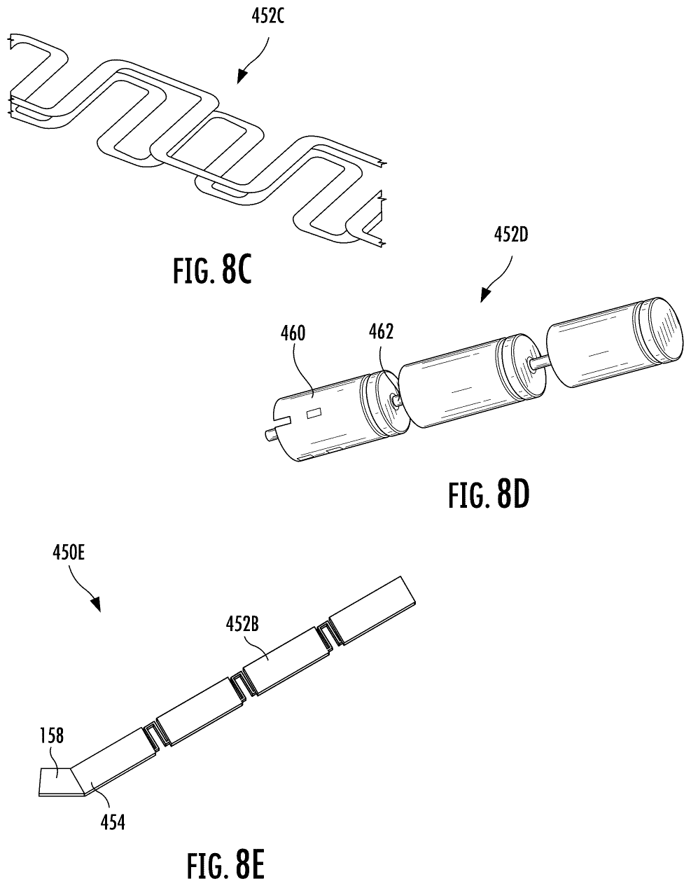

The base 154 of each monopole radiator 152 may be electrically connected to the reflector 210. In some embodiments, the base 154 of each monopole radiator 152 may be galvanically connected to the reflector 210 using solder joints or the like. In other embodiments, the base 154 of each monopole radiator 152 may be capacitively coupled to the reflector 210. In either case, the parasitic monopole elements 150 may optionally include a tab portion 158 (see FIG. 8E) that is connected at the base 154 of the monopole radiator 152. The tab portion 158 may extend at an angle from the monopole radiator 152 (and often is monolithic with the monopole radiator 152). The tab portion 158 may extend parallel to the reflector 210 and may be soldered directly to the reflector 210 or capacitively coupled thereto through a thin dielectric element. The tab portion 158 may facilitate electrically connecting the monopole radiator 152 to the reflector 210. Any such tab portion 158 is not part of the monopole radiator 152 as the tab portion 158 will not act electrically as a monopole but instead is used to electrically connect the monopole radiator 152 to the reflector 210.

The distal end 156 of each monopole radiator 152 is not galvanically connected to the associated radiating element 100, although the distal end 156 may be in relatively close proximity to the associated radiating element 100. The radiating elements 100 may optionally each include a plastic dipole support structure (not shown) that supports the dipole arms 140 and holds them in their proper positions. In some embodiments, these plastic support structures may include snap clips or other mechanical structures that receive the distal ends 156 of the monopole radiator 152 to ensure that the distal ends 156 of the monopole radiator 152 are also maintained in their proper positions. As shown in FIG. 2C, in some embodiments, the distal end 156 of each monopole radiator 152 may be adjacent a distal end 144 of a respective one of the dipole arms 140.

As shown best in FIG. 2C, each monopole radiator 152 may be completely within the footprint of the first and second dipole radiators 120-1, 120-2 when the low-band radiating element 100 is viewed from the front. As the term is used herein, the “footprint” of a pair of dipole radiators refers to the area defined by the perimeters of the two dipole radiators when viewed from the front. Thus, for the low-band radiating element 100, the footprint of dipole radiators 120-1, 120-2 is the large square defined by the outer sides of the combination of the four dipole arms 140-1 through 140-4. The long thin rectangles in FIG. 2C illustrate the positions of the monopole radiator 152 (since the monopole radiator 152 would otherwise mostly be hidden in the view of FIG. 2C). As can be seen, each of the monopole radiator 152 is completely within the footprint of the first and second dipole radiators 120-1, 120-2. It will be appreciated, however, that in other embodiments portions of some or all of the monopole radiator 152 may extend outside the footprint of the first and second dipole radiators 120-1, 120-2. For example, in some embodiments, at least 80% of each monopole radiator 152 may be within the footprint of the first and second dipole radiators 120-1, 120-2. In some embodiments, at least 60% or at least 50% of each monopole radiator 152 may be within the footprint of the first and second dipole radiators 120-1, 120-2.

As is also shown in FIG. 2C, the base 154 of each monopole radiator 152 is closer to the feed stalk 110 than is the distal end 156 of the respective monopole radiator 152. Thus, the base 154 of each monopole radiator 152 is closer to the center of the low-band radiating element 100 when the low-band radiating element 100 is viewed from the front.

As can also be seen from FIG. 2C, each monopole radiator 152 is generally positioned to be near an outer edge of the footprint of its associated radiating element 100. Locating the monopole radiators 152 near the outer edges of the footprint of their associated radiating elements 100 may increase the impact that the parasitic monopole elements 150 have in terms of reducing the azimuth HPBW of the antenna beams generated by the low-band arrays 120. While some or all of each monopole radiator 152 may be positioned outside the footprint of their associated radiating elements 100, as the monopole radiators 152 extend closer to an adjacent low-band array the coupling between the monopole radiators 152 and the adjacent array may eventually become counterproductive and may act to increase rather than decrease the azimuth HPBW of the generated antenna beams. In the depicted embodiment, the base 154 of each monopole radiator 152 is positioned closer to the center of the footprint of the associated radiating element 100 than is the distal end 156 of the monopole radiator 152 so that the length of each monopole radiator 152 may be increased while still positioning the entirety of the monopole radiator 152 behind the associated radiating element 100 and within the footprint thereof. In other embodiments, each monopole radiator 152 may extend directly behind and generally parallel to a respective outer edge of the footprint of the associated radiating element 100.

As discussed above, in some embodiments each monopole radiator 152 may extend forwardly from the reflector 210 at an oblique angle as opposed to at an angle of 90°, as is conventional for monopole radiating elements. Having the monopole radiators 152 extend forwardly from the reflector at an angle of, for example, between 20°-70° may allow each monopole radiator 152 to be positioned completely (or almost completely) behind their associated radiating elements 100 while also having a desired electrical length (which typically is an electrical length where the monopole radiators 152 significantly narrow the beamwidth of the associated radiating element 100 in a lower portion of the operating frequency band of the associated radiating element 100). Moreover, slanting a monopole radiator 152 may also reduce the impact that the monopole radiator 152 has on the cross-polarization discrimination and/or front-to-back performance of its associated radiating element 100. In particular, a monopole radiator 152 that extends from a reflector at an angle of 90° will only have horizontally polarized RF emissions. However, if the monopole radiator 152 is slanted with respect to the reflector it will have both horizontally polarized and vertically polarized RF emissions. By configuring the monopole radiators 152 to emit RF radiation having both have both horizontally polarized and vertically polarized components the impact of the parasitic monopole elements 150 on the cross-polarization discrimination and front-to-back performance of their associated radiating elements 100 may be reduced.

As is understood in the art, the beamwidth of the element patterns of a dipole radiator generally scale inversely with frequency. While base station antenna manufacturers often design radiating elements in a manner that partially compensates for this inverse frequency scaling, the effect is still present with most if not all radiating elements that are designed to operate over a relatively large frequency band. Consequently, a low-band array of radiating elements will typically have the largest beamwidths in the lower portion of the low-band operating frequency band (where the low-band operating frequency band is typically either 617-960 MHz or 696-960 MHz). The parasitic monopole elements according to embodiments of the present invention, such as the parasitic monopole element 150, may be designed to primarily narrow the beamwidth of their associated radiating elements 100 in the lower portion of their operating frequency bands. This may advantageously improve the performance of the associated radiating elements 100 in the portion of their operating frequency bands where their performance is the worst, and may also help to reduce the variation in azimuth HPBW as a function of frequency. Such reduced variation is typically desired by cellular network operators.

One advantage of providing low-band radiating elements that have associated parasitic monopole elements 150 is that the parasitic monopole elements 150 may have little effect on both the impedance matching and cross-polarization isolation of their associated radiating elements. Base station antenna manufacturers exert considerable effort in developing optimized radiating element designs that are typically widely used across many platforms. Since the parasitic monopole elements 150 that are disclosed herein may not significantly impact the impedance matching or cross-polarization isolation performance of their associated radiating elements, the parasitic monopole elements 150 may be added to existing (highly-optimized) radiating elements without any need to redesign the radiating elements. Thus, the parasitic monopole elements 150 according to embodiments of the present invention may be used in conjunction with known radiating element designs to improve certain performance characteristics thereof without significantly negatively degrading other performance parameters of these known radiating elements.

While the monopole radiators 152 of the parasitic monopole elements 150 are illustrated as comprising metal rods (which may be solid or hollow metal rods), it will be appreciated that embodiments of the present invention are not limited thereto. For example, in other embodiments, the monopole radiator 152 may be implemented using stamped sheet metal structures, printed circuit boards, die cast structures and the like. It will also be appreciated that the monopole radiator 152 are not limited to long straight structures. In fact, the monopole radiator 152 themselves have bent distal ends. Numerous other shaped structures may be used including, for example, monopole radiators having multiple bends, spiral-shaped monopoles radiators, or monopole radiators that have inductive and/or capacitive elements incorporated into the monopole element. Example embodiments of such monopole radiators will be discussed in further detail herein.

The parasitic monopole elements 150 are not directly fed by a radio. Instead, a portion of the RF energy that is transmitted by their associated radiating elements 100 will be incident on the parasitic monopole elements 150, and generates RF currents on the monopole radiator 152 thereof, particularly for RF energy in the lower portion of the operating frequency band of the associated radiating elements 100. These RF currents then result in RF radiation from the parasitic monopole elements 150. The parasitic monopole elements 150 may be designed so that the RF radiation emitted by the parasitic monopole elements 150 combines in-phase with the RF radiation emitted by the associated radiating element 100. Moreover, since the parasitic monopole elements 150 are positioned near the periphery of the footprint of the associated radiating elements 100, they tend to broaden the aperture of the associated radiating elements 100, and hence act to narrow the beamwidth of the element pattern of the associated radiating elements 100. In addition, the parasitic monopole elements 150 may also interact with the low-band radiating elements 100 in an adjacent low-band array in a manner that also acts to narrow the azimuth HPBW of the generated low-band antenna beams.

FIG. 3A is a schematic shadow front perspective view of a portion of a base station antenna 200 that includes two arrays 220-1, 220-2 of low-band radiating elements, where the low-band radiating elements are implemented using the low-band cross-dipole radiating element 100 having associated parasitic monopole elements 150 of FIGS. 2A-2C. FIG. 3B is a schematic side view of the base station antenna 200 of FIG. 3A.

As shown in FIGS. 3A-3B, the base station antenna 200 includes a reflector 210, and the radiating elements 100 extend forwardly from the reflector 210. The reflector 210 may be similar or identical to the reflector 110 of the conventional base station antenna 100 that is discussed above, and hence further description of the reflector 210 will be omitted here. Base station antenna 200 further includes a radome 212 that covers and protects the low-band radiating elements 100. The radiating elements 100 may extend forwardly from the reflector 210 to be directly adjacent an inner surface of the radome 212. The monopole radiators 152 of the parasitic monopole elements 150 are slanted, as discussed above, so that they fit within the radome 212 and, optionally, so that they are completely located behind the dipole radiators 120-1, 120-2 of their associated radiating elements 100. As shown in FIGS. 3A-3B, the base station antenna 200 may include additional parasitic elements that are designed to narrow the azimuth HPBWs of the antenna beams generated by the low-band arrays 220, such as isolation walls 214 that may extend forwardly from the reflector 210 and/or cloaked parasitic elements 216 that extend along the sides of the base station antenna at approximately the same distance forwardly from the reflector 210 as the dipole radiators 120 of the low-band radiating elements 100.

Each radiating element 100 in the two low-band arrays 220-1, 220-2 may include four associated parasitic monopole elements 150. In the depicted embodiment, the parasitic monopole elements 150 are all arranged identically, as can be seen in FIG. 3B.

Referring to FIGS. 2A-2C and 3A-3B, base station antenna 200 comprises a reflector 210, a first plurality of cross-dipole radiating elements 100 that are arranged as a first array 220-1 of cross-dipole radiating elements, each cross-dipole radiating element 100 comprising a first dipole radiator 120-1 having a first dipole arm 140-1 and a second dipole arm 140-2 and a second dipole radiator 120-2 having a third dipole arm 140-3 and a fourth dipole arm 140-4. The base station antenna 200 further includes a plurality of parasitic monopole elements 150 that are associated with a first of the cross-dipole radiating elements 100, where each parasitic monopole element 150 includes a monopole radiator 152.

In some embodiments, at least half of each monopole radiator 152 is positioned within a footprint of the first and second dipole radiators 120-1, 120-2 of the first of the cross-dipole radiating elements 100 when the first of the cross-dipole radiating elements 100 is viewed from the front. In other embodiments, at least some of the monopole radiators 152 extend forwardly from the reflector 210 at an angle of between 10° and 80° or at an angle of between 20° and 50°. In still further embodiments, a base 154 of each monopole radiator 152 is positioned closer to a center of the footprint of the first of the cross-dipole radiating elements 100 than is a distal end 156 of each monopole radiator 152. In some embodiments, the distal end 156 of each monopole radiator 152 may be bent (e.g., rearwardly or to the side).

In some embodiments, each monopole radiator 152 has an electrical length of between 0.2 and 0.4 of a wavelength within an operating frequency band of the first array 220-1 or an electrical length of between 0.2 and 0.4 of a center wavelength of an operating frequency band of the first array 220-1. In other embodiments, each monopole radiator 152 has an electrical length of 0.25 of a wavelength within an operating frequency band of the first array 220-1. The monopole radiator 152 may be electrically connected (e.g., capacitively coupled) to the reflector 210.

In some embodiments, a first of the cross-dipole radiating elements 100 may include a total of four associated parasitic monopole elements 150. At least a portion of each monopole radiator 152 may be positioned within a footprint of the first and second dipole radiators 120-1, 120-2 of the first of the cross-dipole radiating elements 100 when the first of the cross-dipole radiating elements 100 is viewed from the front. In some cases, an entirety of each monopole radiator 152 may be positioned within a footprint of the first and second dipole radiators 120-1, 120-2 of the first of the cross-dipole radiating elements 100 when the first of the cross-dipole radiating elements 100 is viewed from the front. All of the cross-dipole radiating elements 100 in the first array 220-1 may include a plurality of associated parasitic monopole elements 150.

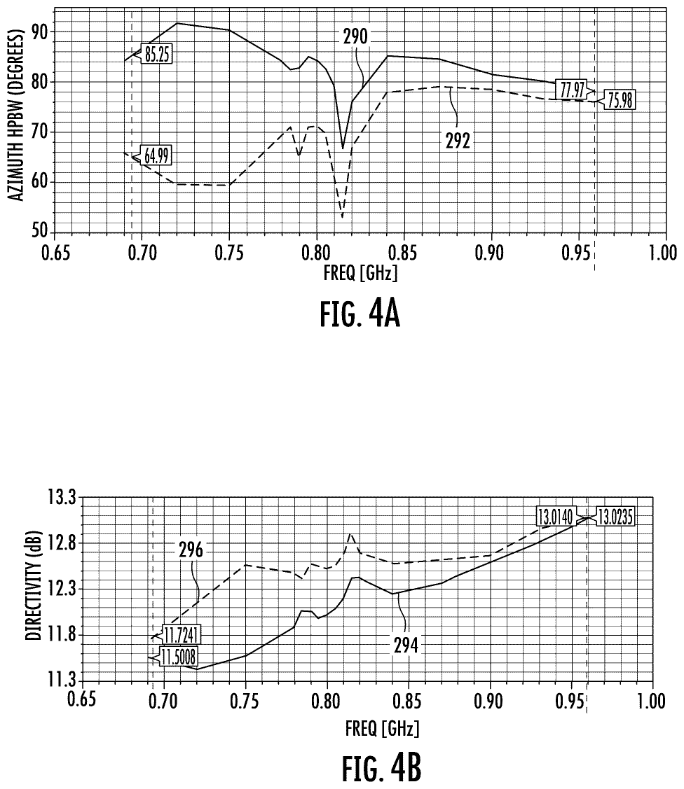

FIGS. 4A and 4B are graphs comparing the simulated azimuth HPBW and directivity, respectively, of the base station antenna 200 of FIGS. 3A-3B as compared to a conventional base station antenna that is identical to base station antenna 200 except that the radiating elements of the conventional base station antenna do not include associated parasitic monopole elements. In FIG. 4A curve 290 represents the simulated azimuth HPBW of the antenna beams generated by each low-band array in the conventional base station antenna and curve 292 represents the simulated azimuth HPBW of the antenna beams generated by each low-band array in the base station antenna 200 of FIGS. 3A-3B.

As shown by curve 290 in FIG. 4A, the azimuth HPBW of the antenna beams generated by the low-band arrays in the conventional antenna peaks at about 92° at 720 MHz and averages about 87° over the lower portion (the 696-800 MHz portion) of the operating frequency range. The azimuth HPBW of the antenna beams generated by the low-band arrays in the conventional antenna exhibits a “null” in the central portion (the 800-840 MHz portion) of the operating frequency range, with the azimuth HPBW being less than 85° throughout this frequency range and less than 70° in the trough of the null. The azimuth HPBW of the antenna beams generated by the low-band array in the conventional antenna decreases generally linearly with a small slope with increasing frequency over the upper portion (the 840-960 MHz portion) of the operating frequency range, ranging from about 85° to about 78° over this frequency range.

As is also shown in FIG. 4A, curve 292 (representing the azimuth HPBW of the antenna beams generated by the low-band arrays in the base station antenna 200) is similar to curve 290, with two significant differences. First, in curve 292 the azimuth HPBWs throughout the lower portion (the 696-800 MHz portion) of the operating frequency range are lower than the azimuth HPBWs in the remainder of the operating frequency range with the exception of the azimuth HPBWs in the sharp null. Second, all of the azimuth HPBWs in curve 292 are lower than the corresponding azimuth HPBWs in curve 290. In the upper portion of the operating frequency range, curve 292 shows that the azimuth HPBWs of the antenna beams generated by each low-band array in the base station antenna 200 are between 3° and 7° less than the corresponding azimuth HPBWs of the antenna beams generated by each low-band array in the conventional base station antenna. In the central portion of the operating frequency range, this effect as magnified, with the azimuth HPBWs of the antenna beams generated by each low-band array in the base station antenna 200 are between 7° and 13° less than the corresponding azimuth HPBWs of the antenna beams generated by each low-band array in the conventional base station antenna. The largest differences in azimuth HPBW occur in the lower portion of the operating frequency range, with the azimuth HPBWs of the antenna beams generated by each low-band array in the base station antenna 200 are between 11° and 32° less than the corresponding azimuth HPBWs of the antenna beams generated by the low-band arrays in the conventional base station antenna. Thus, FIG. 4A shows that the addition of the parasitic monopole elements 150 results in a significant reduction in the azimuth HPBWs of the generated low-band antenna beams, particularly in the lower portion of the operating frequency range.

Referring next to FIG. 4B, it can be seen that the directivity of the antenna beams generated by the low-band arrays in the two base station antennas generally tracks the differences in the azimuth HPBWs. In particular, curve 294 in FIG. 4B represents the directivity (in dB) of the antenna beams generated by each low-band array in the conventional base station antenna, while curve 296 represents the directivity of the antenna beams generated by each low-band array in the base station antenna 200 of FIGS. 3A-3B. As shown, in the lower portion of the operating frequency band, the base station antenna 200 exhibits at least a 0.22 dB improvement in directivity, and an average increase in directivity of more than 0.5 dB, which is significant. Smaller increases in directivity are achieved in the remainder of the operating frequency range, with the improvement in directivity generally decreasing with increasing frequency. The average increase in directivity exceeds 0.4 dB

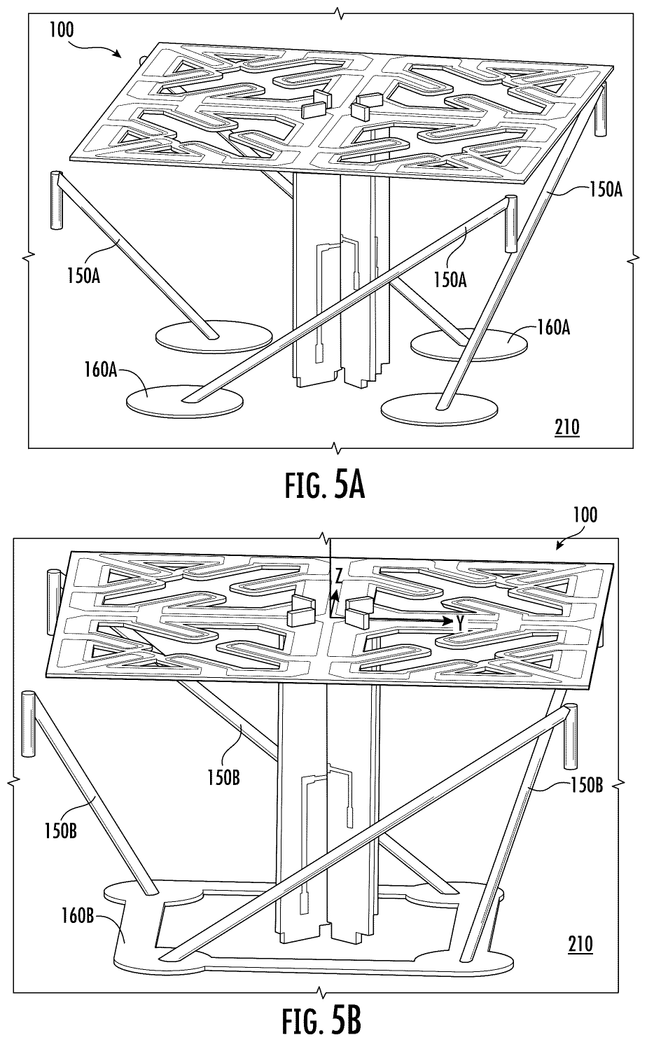

FIGS. 5A and 5B are schematic front perspective views of low-band cross-dipole radiating element 100 that have associated parasitic monopole elements 150A and 150B, respectively, according to further embodiments of the present invention. As shown in FIG. 5A, parasitic monopole element 150A may be identical to parasitic monopole element 150, except that parasitic monopole element 150A further includes a metal pad 160A, and the base 154 of monopole radiator 152 extends forwardly from the metal pad 160A at an oblique angle. The base 154 of the monopole radiator 152 may, for example, be soldered to the metal pad 160A. The metal pad 160A may be mounted on the reflector of a base station antenna (e.g., reflector 210 of base station antenna 200), typically with a thin dielectric spacer (not shown) such as a solder mask disposed between the metal pad 160A and the reflector 210 so that the metal pad 160A is capacitively coupled to the reflector 210. The size of the metal pad 160A and/or the thickness and dielectric constant of the dielectric spacer may be selected to achieve a desired amount of capacitive coupling between the metal pad 160A and the reflector 210. FIG. 5B illustrates a parasitic monopole element 150B that is similar to parasitic monopole element 150A except that a large metal plate 160B is provided and the monopole radiators 152 are soldered to the large metal plate 160B.

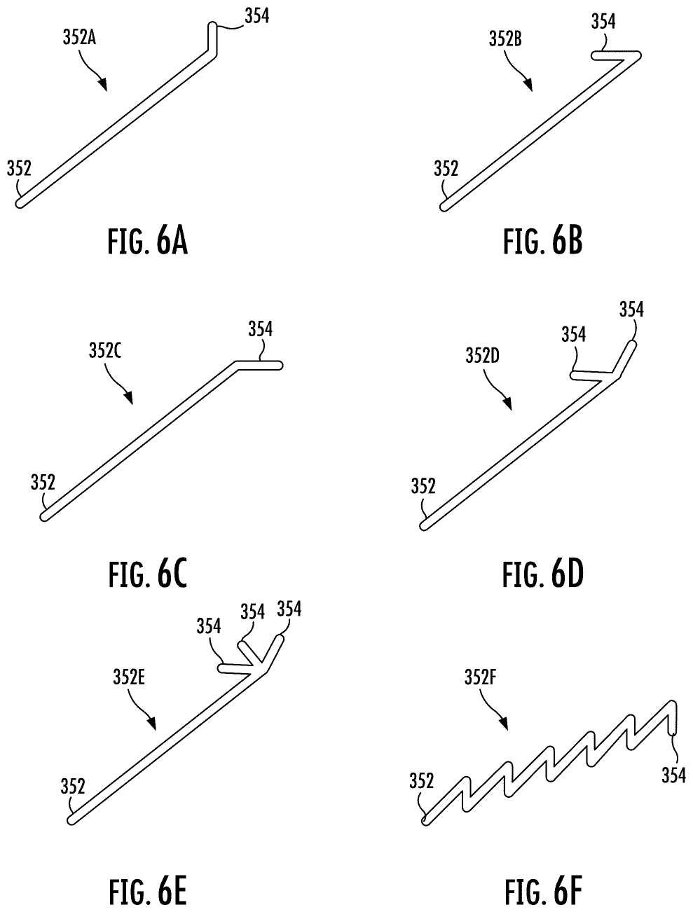

It will also be appreciated that the parasitic monopole elements according to embodiments of the present invention may have monopoles with a wide variety of different designs. FIGS. 6A-6F are schematic side views of the monopole radiators 352A-352F of additional parasitic monopole elements according to embodiments of the present invention. As shown in FIGS. 6A-6C, the monopole radiator 152 of parasitic monopole element 150 may be replaced with monopole radiators 352A-352C, respectively, in which the distal end 354 of the monopole radiator is bent in a different direction. In particular, in FIG. 6A, the distal end 354 of the monopole radiator 352A is bent forwardly, while in FIGS. 6B-6C, the distal ends 354 of the monopole radiators 352B, 352C are bent to transversely (i.e., to the side). As shown in FIGS. 6D and 6E, in other embodiments the monopole radiators 352D, 352E may have multiple distal ends. Bending the monopole allows the electrical length of the monopole to be increased without increasing its footprint, and having multiple end segments that are bent at different directions allows the monopole have a more symmetrical structure. Finally, as shown in FIG. 6F, in yet another embodiment, a monopole radiator 352F is provided that includes a plurality of sections where adjacent sections form relatively sharp angles, thereby achieving a desired electrical length while having a much smaller effective physical length.

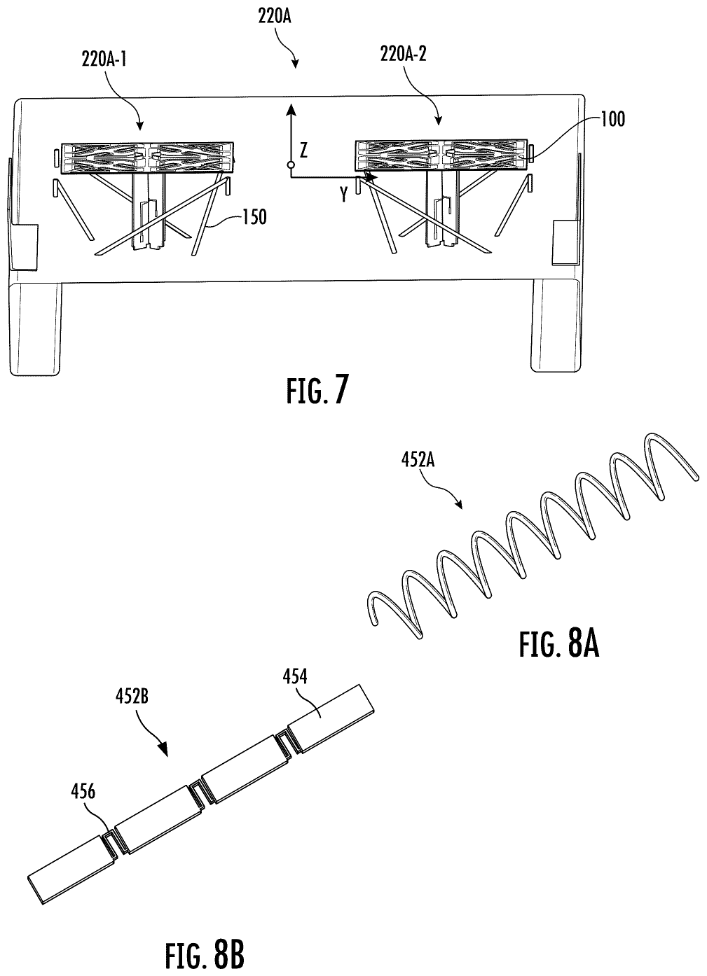

FIG. 7 is a schematic side perspective view a base station antenna 200A according to further embodiments of the present invention that includes side-by-side arrays 220A-1, 220A-2 of low-band cross-dipole radiating elements 100 having associated parasitic monopole elements 150 (note that only one radiating element 100 of each low-band array 220A is shown in FIG. 7). Base station antenna 200A may be identical to base station antenna 200 of FIGS. 3A-3B, except that in base station antenna 200A the parasitic monopole elements 150 associated with the low-band radiating elements 100 in the first low-band array 220A-1 are arranged as mirror images with respect to the parasitic monopole elements 150 associated with the low-band radiating elements 100 in the second low-band array 220A-2. Configuring the parasitic monopole elements 150 as mirror images as shown in FIG. 7 may improve the cross-polarization discrimination and/or front-to-back performance as compared to the base station antenna 200 of FIGS. 3A-3B. However, the azimuth HPBW is more stable when the parasitic monopole elements 150 are arranged in the same manner in each low-band array (i.e., not as mirror images) as in the base station antenna 200 of FIGS. 3A-3B, and also achieve slightly higher directivity.

FIGS. 8A-8E are schematic perspective views of the cloaked monopole radiators that may be used to form the monopole radiators of any of the parasitic monopole elements according to embodiments of the present invention. As discussed above, scattering may occur when RF radiation emitted by a higher frequency band array of radiating elements in a base station antenna impinges on the radiating elements of a lower frequency band array in the base station antenna. Since the parasitic monopole elements according to embodiments of the present invention have monopole radiators that may be about % of a wavelength in the low-band operating frequency range, the monopole radiators of the parasitic monopole elements according to embodiments of the present invention may also cause scattering of the RF radiation emitted by nearby mid-band radiating elements.

In order to suppress such distortion of the mid-band antenna beams, the parasitic monopole elements according to embodiments of the present invention may include monopole radiators that are “cloaked” so as to be substantially transparent to RF energy radiated by nearby linear arrays that operate in other frequency bands. Techniques for cloaking dipole radiators to have reduced or no impact on the antenna beams generated by nearby higher frequency band arrays are well known in the art. These same techniques may be used to cloak the monopole radiators of the parasitic elements according to embodiments of the present invention.

For example, FIG. 8A is a schematic perspective view of a cloaked monopole radiator 452A that may be used in any of the parasitic monopole elements according to embodiments of the present invention. As shown, instead of being a straight, rod-like monopole radiator, the monopole radiator 452A has a spiral (helical) shape. As explained in detail in U.S. patent application Ser. No. 18/533,371 (“the '371 application”), filed Dec. 8, 2023, spiral radiators may be designed to be cloaked in selected frequency bands. The entire content of the '371 application is incorporated herein by reference. It will be appreciated that nay of the spiral dipole arm designs disclosed in the '371 application may be used to form monopole radiators that can be used in the parasitic monopole elements according to embodiments of the invention.

FIG. 8B is a schematic perspective view of a cloaked monopole radiator 452B that may alternatively be used in any of the parasitic monopole elements according to embodiments of the present invention. As shown, instead of having rod-like monopole radiator, the monopole radiator 452B is formed as a plurality of widened conductive (e.g., metal) segments 454 that are interconnected by meandered conductive traces 456. As explained above with respect to the dipole arms 140 of radiating element 100, the widened conductive segments 454 and meandered conductive traces 456 may be designed so that the monopole radiator 452B is cloaked in a selected frequency range. Monopole radiator 452B may be implemented, for example, from stamped sheet metal or on a rigid or flexible printed circuit board.

FIG. 8C is a schematic perspective view of a cloaked monopole radiator 452C that may be used in any of the parasitic monopole elements according to embodiments of the present invention. As shown, monopole radiator 452C comprises a pair of overlapping traces. As explained in detail in U.S. Patent Publication No. 2023/0071050 (“the '050 publication”), published Mar. 9, 2023, the overlapping traces may be designed to be cloaked in selected frequency bands. The entire content of the '050 publication is incorporated herein by reference. It will be appreciated that nay of the cloaked dipole arm designs disclosed in the '050 publication may be used to form monopole radiators that can be used in the parasitic monopole elements according to embodiments of the invention.

FIG. 8D is a schematic perspective view of a cloaked monopole radiator 452D that may be used in any of the parasitic monopole elements according to embodiments of the present invention. As shown, monopole radiator 452D comprises a series of dipole segments 460 that are connected by RF chokes 462. As explained in detail in U.S. Pat. No. 10,644,401 (“the '401 patent”), issued May 5, 2020, the RF chokes 462 may be designed to cloak the dipole segments in selected frequency bands. The entire content of the '401 patent is incorporated herein by reference.

FIG. 8E is a schematic perspective view of a parasitic monopole element 450E that includes the cloaked monopole radiator 452B of FIG. 8B and that further includes a tab 158 that extends from the base 454 of parasitic radiator 452B. The tab 158 may be designed to extend parallel to a reflector of a base station antenna when the parasitic monopole element 450E is installed therein.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Herein, the term “substantially” refers to variation of less than 10%.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
a reflector;
a first plurality of cross-dipole radiating elements that are arranged as a first array of cross-dipole radiating elements, each cross-dipole radiating element comprising a first dipole radiator having a first dipole arm and a second dipole arm and a second dipole radiator having a third dipole arm and a fourth dipole arm; and
a plurality of parasitic monopole elements that are associated with a first of the cross-dipole radiating elements, each parasitic monopole element including a monopole radiator, wherein at least half of each monopole radiator is positioned within a footprint of the first and second dipole radiators of the first of the cross-dipole radiating elements when the first of the cross-dipole radiating elements is viewed from the front.

2. The base station antenna of claim 1, wherein each monopole radiator has an electrical length of between 0.2 and 0.4 of a wavelength within an operating frequency band of the first array.

3-5. (canceled)

6. The base station antenna of claim 1, wherein the entirety of each monopole radiator is positioned within a footprint of the first and second dipole radiators when the first of the cross-dipole radiating elements is viewed from the front.

7. (canceled)

8. The base station antenna of claim 1, wherein at least some of the monopole radiators extend forwardly from the reflector at an angle of between 20° and 50°.

9. The base station antenna of claim 1, wherein a base of each monopole radiator is mounted to extend forwardly from the reflector, and a distal end of each monopole radiator is bent.

10. (canceled)

11. The base station antenna of claim 1, wherein the first of the cross-dipole radiating elements includes a total of four associated parasitic monopole elements.

12-13. (canceled)

14. The base station antenna of claim 1, wherein at least some of the parasitic monopole elements are cloaked to be substantially transparent to RF energy in an operating frequency band of an array of higher frequency band radiating elements that is included in the base station antenna.

15. The base station antenna of claim 1, wherein at least some of the monopole radiators include at least a section that is spiraled.

16. The base station antenna of claim 1, wherein a base of each monopole radiator is positioned closer to a center of the footprint of the first of the cross-dipole radiating element than is a distal end of each monopole radiator.

17. The base station antenna of claim 1, wherein at least one of the monopole radiators includes at least two capacitively coupled conductive segments and at least one meandered inductive segment.

18. (canceled)

19. The base station antenna of claim 1, wherein the monopole radiators are capacitively coupled to the reflector.

20. A base station antenna, comprising:
a reflector:
a first plurality of cross-dipole radiating elements that are arranged as a first array of cross-dipole radiating elements, each cross-dipole radiating element comprising a first dipole radiator having a first dipole arm and a second dipole arm and a second dipole radiator having a third dipole arm and a fourth dipole arm; and
a plurality of parasitic monopole elements that are associated with a first of the cross-dipole radiating elements, each parasitic monopole element including a monopole radiator, wherein each monopole radiator is positioned at least partly within a footprint of the first and second dipole radiators of the first of the cross-dipole radiating elements when the first of the cross-dipole radiating elements is viewed from the front, and
wherein at least some of the monopole radiators extend forwardly from the reflector at an angle of between 10° and 80°.

21. (canceled)

22. The base station antenna of claim 20, wherein the monopole radiators are capacitively coupled to the reflector.

23. The base station antenna of claim 20, wherein at least half of each monopole radiator is positioned within a footprint of the first and second dipole radiators when the first of the cross-dipole radiating elements is viewed from the front.

24. (canceled)

25. The base station antenna of claim 20, wherein a distal of each monopole radiator is positioned adjacent a distal end of a respective one of the first through fourth dipole arms of the first of the cross-dipole radiating elements.

26. (canceled)

27. The base station antenna of claim 20, wherein at least one of the monopole radiators includes at least a section that is spiraled.

28. The base station antenna of claim 20, wherein a base of each monopole radiator is positioned closer to a center of the footprint of the first of the cross-dipole radiating element than is a distal end of each monopole radiator.

29. (canceled)

30. A base station antenna, comprising:
a reflector;
a first plurality of cross-dipole radiating elements that are arranged as a first array of cross-dipole radiating elements, each cross-dipole radiating element comprising a first dipole radiator having a first dipole arm and a second dipole arm and a second dipole radiator having a third dipole arm and a fourth dipole arm; and
a plurality of parasitic monopole elements that are associated with a first of the cross-dipole radiating elements, each parasitic monopole element including a monopole radiator, wherein a base of each monopole radiator is positioned closer to a center of the footprint of the first of the cross-dipole radiating element than is a distal end of each monopole radiator.

31-32. (canceled)

33. The base station antenna of claim 30, wherein the base of each monopole radiator is positioned within a footprint of the first and second dipole radiators when the first of the cross-dipole radiating elements is viewed from the front.

34. (canceled)

35. The base station antenna of claim 30, wherein each of the cross-dipole radiating elements in the first array includes a total of four associated parasitic monopole elements.

36. (canceled)

37. The base station antenna of claim 30, wherein at least some of the monopole radiators are cloaked to be substantially transparent to RF energy in an operating frequency band of an array of higher frequency band radiating elements that is included in the base station antenna.

38-58. (canceled)
